(19) United States
(12) Patent Application Publication
(10) Pub. No.: US 2025/0306287 A1
(43) Pub. Date: Oct. 2, 2025

(54) TAPERED OPTICAL FEATURES FOR OPTICAL FIBER CONNECTIONS

(71) Applicant: Intel Corporation, Santa Clara, CA (US)

(72) Inventors: Dekang Chen, Chandler, AZ (US); Fan Fan, Chandler, AZ (US); Zhichao Zhang, Chandler, AZ (US); Saikumar Jayaraman, Chandler, AZ (US); Kumar Abhishek Singh, Phoenix, AZ (US); Feifei Cheng, Chandler, AZ (US)

(73) Assignee: Intel Corporation, Santa Clara, CA (US)

(21) Appl. No.: 18/621,754

(22) Filed: Mar. 29, 2024

(51) Int. Cl. G02B 6/30; G02B 6/293

(52) U.S. Cl. CPC G02B 6/305; G02B 6/29332

(57) ABSTRACT

An apparatus includes an optical fiber coupled with a photonic integrated circuit (PIC) die. A first optical feature is at an end face of the optical fiber. The first optical feature tapers in a first longitudinal direction from a first base end proximal to the end face to a first tapered end. A second optical feature is at a surface of the PIC die. The second optical feature tapers in a second longitudinal direction from a second base end proximal to the surface to a second tapered end. The first optical feature is adjacent to, and may be longitudinally aligned with or parallel to, the second optical feature.

### GOVERNMENT INTEREST STATEMENT

This invention was made with government support under Agreement No. N00164-19-9-0001, awarded by NSWC Crane Division. The government has certain rights in the invention.

### BACKGROUND

In electronics manufacturing, integrated circuit (IC) packaging is a stage of semiconductor device fabrication in which an IC that has been monolithically fabricated on a chip (or die) is assembled into a “package” that can protect the IC chip from physical damage. The package can also communicatively connect the IC chip to other packaged IC chips and/or a scaled host component, such as a package substrate, or a printed circuit board. Multiple IC chips can be co-assembled, for example, into a multi-die package (MCP).

A photonic integrated circuit (PIC) includes integrated photonic devices or elements. Silicon PICs (SiPh) have one or more silicon photonic waveguides that convey light within the PIC. These silicon waveguides can terminate at end surfaces suitable for coupling with optical fibers.

One challenge faced when connecting an optical fiber to a PIC die is to minimize the coupling loss between the fiber and the end surface of the waveguide within the PIC die. The end face of the optical fiber needs to be precisely aligned with the end surface of the waveguide on a surface of the PIC die. Coupling loss occurs when an optical fiber is misaligned. Because of the small dimensions involved, it can be challenging to precisely align the optical fiber with the waveguide on the surface of the PIC die in an efficient manner.

### BRIEF DESCRIPTION OF THE DRAWINGS

The subject matter described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Views referred to as “cross-sectional”, “profile” and “plan” correspond to orthogonal planes within a cartesian coordinate system. Thus, cross-sectional and profile views are taken in the x-z plane, and plan views are taken in the x-y plane. Typically, profile views in the x-z plane are cross-sectional views. Where appropriate, drawings are labeled with axes to indicate the orientation of the figure. Further, where considered appropriate, reference labels have been repeated among the figures to indicate corresponding or analogous elements. In the figures:

FIG. 1A illustrates a cross-sectional view of an optical fiber coupled with a photonic integrated circuit (PIC) die on a package substrate, in accordance with some embodiments;

FIG. 1B illustrates a cross-sectional view of a region of the optical fiber and PIC die depicted in FIG. 1A, in accordance with some embodiments;

FIGS. 1C and 1D are sectional views of the portions of optical fiber depicted in FIG. 1B, in accordance with some embodiments;

FIG. 1E illustrates a cross-sectional view of the region of the optical fiber and PIC die depicted in FIG. 1B, in accordance with some embodiments;

FIG. 2 illustrates an isometric view of an optical fiber and a PIC die in which a first optical feature is adjacent to a second optical feature, according to some embodiments;

FIG. 3A illustrates cross-sectional a side view of an apparatus that includes a first optical feature on an optical fiber that is adjacent and parallel to a second optical feature on surface of a PIC die, in accordance with some embodiments;

FIG. 3B illustrates a side view the first optical feature and second optical feature depicted in FIG. 3A, in accordance with some embodiments;

FIG. 3C illustrates an isometric view of the apparatus of FIG. 3A, in accordance with some embodiments;

FIGS. 4A and 4C are cross-sectional views of an apparatus comprising an optical feature on a surface of a PIC die, in accordance with some embodiments;

FIG. 4B is a plan view of the portion of the PIC die shown in FIG. 4A;

FIGS. 4D and 4E illustrate side and plan views of the apparatus of FIG. 3A and FIG. 3C in which an optical feature on an end face of an optical fiber is adjacent to the optical feature on the surface of a PIC die depicted in FIGS. 4A and 4C, in accordance with some embodiments;

FIG. 4F illustrates a cross-sectional side view of the same apparatus depicted in FIG. 4D, which includes an optical feature at an end face of an optical fiber adjacent to and coupled with an optical feature on a surface of a PIC die, in accordance with some embodiments;

FIG. 5A illustrates a cross-sectional side view of an apparatus comprising a plurality of first optical features, each at an end face of an optical fiber, a plurality of second optical features on a surface of a PIC die, and a component for holding the optical fibers, in accordance with some embodiments;

FIG. 5B illustrates a plan side view of the apparatus depicted in FIG. 5A;

FIG. 6 illustrates a mobile computing platform and a data server machine employing one or more apparatus comprising an optical feature at an end face of an optical fiber coupled with an optical feature on a surface of a PIC die, in accordance with some embodiments; and

FIG. 7 is a functional block diagram of an electronic computing device, in accordance with some embodiments.

### DETAILED DESCRIPTION

Embodiments are described with reference to the enclosed figures. While specific configurations and arrangements are depicted and discussed in detail, this is done for illustrative purposes only. Persons skilled in the relevant art will recognize that other configurations and arrangements are possible without departing from the spirit and scope of the description. It will be apparent to those skilled in the relevant art that techniques and/or arrangements described herein may be employed in a variety of other systems and applications other than what is described in detail herein.

Reference is made in the following detailed description to the accompanying drawings, which form a part hereof and illustrate exemplary embodiments. Further, it is to be understood that other embodiments may be utilized and structural and/or logical changes may be made without departing from the scope of claimed subject matter. It should also be noted that directions and references, for example, up, down, top, bottom, and so on, may be used merely to facilitate the description of features in the drawings. Therefore, the following detailed description is not to be taken in a limiting sense and the scope of claimed subject matter is defined solely by the appended claims and their equivalents.

In the following description, numerous details are set forth. However, it will be apparent to one skilled in the art, that embodiments may be practiced without these specific details. In some instances, well-known methods and devices are shown in block diagram form, rather than in detail, to avoid obscuring the embodiments. Reference throughout this specification to “an embodiment” or “one embodiment” or “some embodiments” means that a particular feature, structure, function, or characteristic described in connection with the embodiment is included in at least one embodiment. Thus, the appearances of the phrase “in an embodiment” or “in one embodiment” or “some embodiments” in various places throughout this specification are not necessarily referring to the same embodiment. Furthermore, the particular features, structures, functions, or characteristics may be combined in any suitable manner in one or more embodiments. For example, a first embodiment may be combined with a second embodiment anywhere the particular features, structures, functions, or characteristics associated with the two embodiments are not mutually exclusive.

As used in the description and the appended claims, the singular forms “a”, “an” and “the” are intended to include the plural forms as well, unless the context clearly indicates otherwise. It will also be understood that the term “and/or” as used herein refers to and encompasses all possible combinations of one or more of the associated listed items.

The terms “coupled” and “connected,” along with their derivatives, may be used herein to describe functional or structural relationships between components. These terms are not intended as synonyms for each other. Rather, in particular embodiments, “connected” may be used to indicate that two or more elements are in direct physical, optical, or electrical contact with each other. “Coupled” may be used to indicated that two or more elements are in either direct or indirect (with other intervening elements between them) physical or electrical contact with each other, and/or that the two or more elements co-operate or interact with each other (e.g., as in a cause-and-effect relationship).

The terms “over,” “under,” “between,” and “on” as used herein refer to a relative position of one component or material with respect to other components or materials where such physical relationships are noteworthy. For example, in the context of materials, one material or layer over or under another may be directly in contact or may have one or more intervening materials or layers. Moreover, one material between two materials or layers may be directly in contact with the two materials/layers or may have one or more intervening materials/layers. In contrast, a first material or layer “on” a second material or layer is in direct physical contact with that second material/layer. Similar distinctions are to be made in the context of component assemblies.

As used throughout this description, and in the claims, a list of items joined by the term “at least one of” or “one or more of” can mean any combination of the listed terms. For example, the phrase “at least one of A, B or C” can mean A; B; C; A and B; A and C; B and C; or A, B and C.

Unless otherwise specified in the specific context of use, the term “predominantly” means more than 50%, or more than half. For example, a composition that is predominantly a first constituent means more than half of the composition is the first constituent (e.g., <50 at. %). The term “primarily” means the most, or greatest, part. For example, a composition that is primarily a first constituent means the composition has more of the first constituent than any other constituent. A composition that is primarily first and second constituents means the composition has more of the first and second constituents than any other constituent. The term “substantially” means there is only incidental variation. For example, composition that is substantially a first constituent means the composition may further include <1% of any other constituent. A composition that is substantially first and second constituents means the composition may further include <1% of any constituent substituted for either the first or second constituent.

One challenge faced when connecting an optical fiber to a PIC die is to minimize the coupling loss between the fiber and an end surface of a waveguide on a surface of the PIC die. The end face of the optical fiber needs to be aligned with the end surface of the waveguide. Coupling loss arises when the optical fiber is misaligned. Because the mode field diameter (MFD) of the optical fiber may be less than 10 μm, the end face of the fiber typically needs to aligned within 1 μm to 2 μm of the end surface of the waveguide. An optical fiber and a waveguide can be directly coupled. However, it is challenging to align the fiber with the waveguide within required alignment tolerances.

To facilitate alignment between an optical fiber and a waveguide withing a PIC die, lenses may be provided on the tip of the optical fiber and the end surface of the waveguide. In the case of light being transmitted to the PIC die, the lens on the optical fiber expands the beam, while the lens on the PIC die collimates the expanded beam, focusing the light onto the end surface of the waveguide. The use of lenses can increase beam diameter between the two lenses to as much as high as 80 μm. A “beam expansion” approach using lenses can provide an offset tolerance of up to 20 μm, which facilitates alignment. However, the lens for the optical fiber needs to be precisely aligned with the core of the fiber. Similarly, the lens for the waveguide needs to precisely aligned with the end surface of the waveguide. Typically, active alignment is required to align the respective lenses with the optical fiber and waveguide. While beam expansion using lenses facilitates alignment, the necessary active alignment process increases production time and cost.

In another approach, lenses may be directly printed onto the tip of the optical fiber and the end surface of the waveguide. However, lenses have relatively large dimensions and printing time is correlated with the size of the object being printed. To avoid aperture effects, lenses may be 100 μm or greater in height and may have a thickness of approximately 500 μm. Because of the large dimensions, direct printing of lenses is time consuming.

An advantage of embodiments described herein is that active alignment of lenses with optical fiber or PIC waveguide end surface is not required. Another advantage of embodiments described herein is that time consuming operations associated with printing lenses on the tip of the optical fiber and the end surface of the waveguide is not required. As described below, embodiments are directed to printing tapered optical features on an end face of an optical fiber and on a surface of a PIC die. The dimensions of the tapered optical features may be much smaller than lenses. Accordingly, the time needed to print a tapered optical feature may take much less time than the time required to print a lens. Because of their smaller dimensions as compared with a lens, up to 10,000 tapered optical features may be printed in the time required to print a single lens.

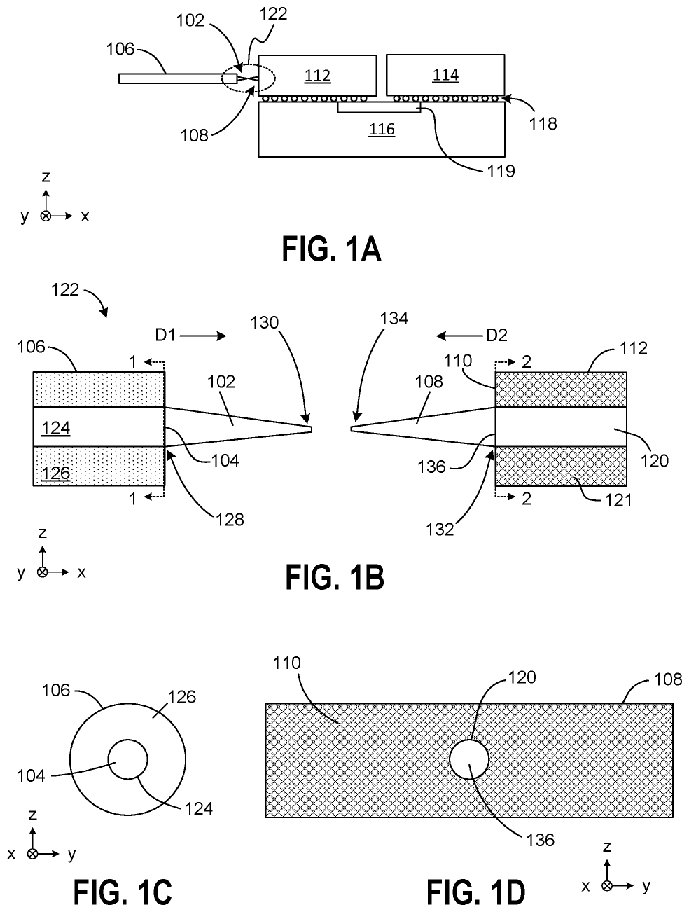

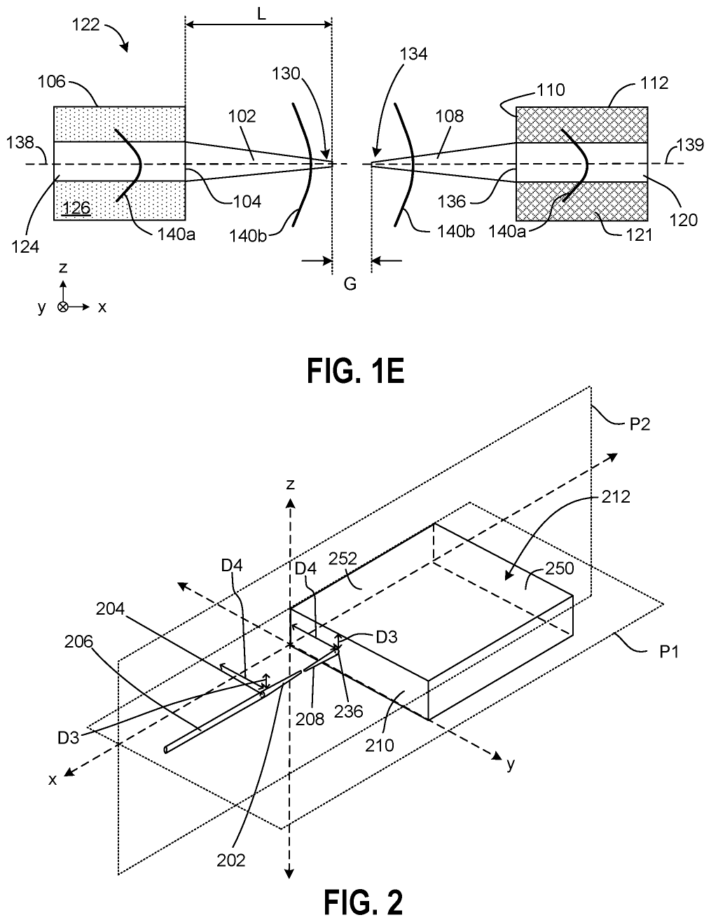

FIGS. 1A-1E and FIG. 2 illustrate views of a first optical feature at an end face of an optical fiber end-to-end coupled with a second optical feature on a surface of a photonic integrated circuit (PIC) die, in accordance with some embodiments. A first optical feature 102 is proximal to an end face 104 of optical fiber 106 and tapered in a first direction D1. A second optical feature 108 is proximal to a surface 110 of PIC die 112 and tapered in a second direction D2. The first optical feature 102 is adjacent to the second optical feature 108 in a spatial relationship that, along with the tapered shape of the optical features, make the first and second optical features 102, 108 operable to couple optical signals between the optical fiber 106 and the PIC die 112.

In various embodiments, the first optical feature 102 may be formed by directly printing the feature on the end face 104 of the optical fiber 106. Similarly, the second optical feature 108 may be formed by directly printing the feature on a surface 110 of PIC die 112. Two-photon polymerization (2PP) is a technique that may be used to fabricate (or print) three-dimensional photonic structures directly on the end of face an optical fiber or an end surface of a waveguide, according to some embodiments. The 2PP technique allows structures to be fabricated in a photosensitive material without a photomask. The 2PP technique is capable of printing features as small as 30 nm to 50 nm with good positional accuracy. The first and second optical features 102, 108 may comprise any material with suitable optical properties, e.g., a polymer. In some embodiments, the first and second optical features 102, 108 may be an epoxy resin, glass, or semiconductor materials, e.g. Si, SiNi, etc. Advantageously, the tapered optical features fabricated using 2PP 3D printing, and described herein, are compatible with temperatures encountered in reflow processes, e.g., up to 260° C.

FIG. 1A illustrates a side view of optical fiber 106 and PIC die 112 in which first optical feature 102 is adjacent to second optical feature 108, in accordance with some embodiments. Optical fiber 106 may be held in positional relationship with PIC die 112 by any suitable device or feature. For example, optical fiber 106 may be held in positional relationship with PIC die 112 with a fiber array unit (FAU), a ferrule, a housing, or by a V-groove in a surface of the PIC die 112 (not shown in FIG. 1A). While a single optical fiber 106 is illustrated, it should be appreciated that multiple optical fibers 106 may be held in positional relationship with PIC die 112 in some embodiments.

PIC die 112 may include circuitry to receive optical signals from a source, e.g., optical fiber 106, and convert optical signals to electrical signals. Similarly, PIC die 112 may include circuitry to receive electrical signals and generate optical signals based on electrical signals. PIC die 112 may include optical components such as lasers or other light sources, detectors, waveguides, and other optical elements, e.g., couplers or filters. PIC die 112 may include one or more planar silicon photonic waveguides, which convey light within the PIC die. PIC die 112 may include electrical components, such as active components, e.g., transistors, and passive components, e.g., conductive vias and lines. In embodiments, PIC die 112 comprises a plurality of outer surfaces and one or more waveguides within the PIC die 112 that terminate at or on one or more of the surfaces, e.g., surface 110 of PIC die 112. PIC die 112 and an integrated circuit (IC) chip 114 may be attached to a package substrate 116 by interconnections 118. IC chip 114 may include electrical circuits operable to perform logic functions, communication functions, data manipulation, or data storage functions, e.g., processors, transmitters, receivers, logic, memory, and the like. Package substrate 116 may provide power and communication signals to PIC die 112 and IC chip 114 via interconnections 118. In addition, package substrate may provide PIC die 112 and IC chip 114 with physical support and mechanical protection. Package substrate 116 may comprise silicon, organic material, glass, metal, other suitable materials, or a combination of these materials. Interconnections 118 may be any suitable type of interconnection, e.g., solder. In some embodiments, PIC die 112 and IC chip 114 are communicatively coupled via a bridge 119 embedded in package substrate 116.

FIG. 1B illustrates a cross-sectional view of region 122 of optical fiber 106 and PIC die 112 depicted in FIG. 1A, in accordance with some embodiments. FIG. 1C is a sectional view of the portion of optical fiber 106 depicted in FIG. 1B along dashed line 1-1. FIG. 1D is a sectional view of the portion of PIC die 112 depicted in FIG. 1B along dashed line 2-2. As may be seen in these figures, optical fiber 106 includes a core 124. The core 124 may be a glass, such as fused silica (SiO2), a polymer, or another suitable transparent material in which light can travel. The core 124 may be cylindrical in cross section and surrounded by cladding 126. The cladding 126 may also be cylindrical in cross section. In some embodiments, a plastic coating (not shown in the figures) may surround the cladding 126. The cladding 126 may be fused silica, but with a lower refractive index than the core 124. Core 124 and cladding 126 may have any suitable diameters. In some embodiments, core 124 has a diameter of between 3 and 100 μm and cladding 126 has a diameter of between 50 and 125 μm. Optical fiber 106 may be a single mode fiber (SMF) in various embodiments. The wavelength of light transmitted in the optical fiber 106, and the refractive indices of the core 124 and cladding 126 may be selected so that light travels in the optical fiber according to the total internal reflection (TIR) phenomena. Light transmitted through optical fiber 106 may have any suitable wavelength. In some embodiments, light transmitted through optical fiber 106 may have a wavelength in the near infrared band (0.7 μm to 2 μm), e.g., O-band 1310 nm, C-band 1550 nm, etc.

Referring to FIGS. 1B and 1C, the first optical feature 102 may be proximal to, at, or on an end face 104 of the core 124 of optical fiber 106. The first optical feature 102 may taper in a first longitudinal direction D1 from a first base end 128 proximal, at, or on the end face 104 to a first tapered end 130. Referring to FIGS. 1B and 1D, PIC die 112 includes a surface 110, material 121, and a waveguide 120. The second optical feature 108 is proximal to, at, or on a surface of the PIC die 112, e.g., the surface 110. The second optical feature 108 may taper in a second longitudinal direction D2 from a second base end 132 proximal to, at, or on the surface of PIC die 112 to a second tapered end 134. In an embodiment, an end surface 136 of waveguide 120, may terminate at surface 110, and the second base end 132 may be proximal to, at, or on end surface 136. Second direction D2 may be opposite the direction D1.

Optical fiber carries energy in the form of a confined electromagnetic wave. Optical fiber with a core diameter less than about ten times the wavelength of the propagating light is modeled using Maxwell's equations instead of geometric optics. Particular transverse field patterns with specific amplitudes and polarization profiles are referred to as optical modes. One property used to characterize optical mode is mode field diameter (MFD). The MFD of an optical fiber is a measure of the spatial extent of the electromagnetic field distribution of a particular mode propagating through the core of the optical fiber. MFD represents the diameter of the region within the optical fiber where most of the optical power of a given mode is confined. Waveguide analysis shows that the light energy in the optical fiber is not completely confined in the core. In embodiments, an optical fiber may be a single mode fiber (SMF) with an MFD smaller than 10 μm.

Generally, the MFD of light propagating in an optical fiber 106 or a waveguide within the PIC is constant. However, when light propagates through the tapered first or second optical feature, 102, 108, the MFD changes. Optical mode confinement diminishes when the core size of the fiber or waveguide decreases. As a result, the beam expands as the waveform moves from base end to tapered end. Conversely, the beam contracts as the waveform moves from tapered end to base end. In configurations, where the waveguide's lateral plane shape maintains symmetry, the optical mode will remain constrained within the waveguide (or optical fiber) even when the core size is infinitesimally small. This permits the MFD to be expanded by up to tens of microns without the optical mode leaking out of the waveguide (or optical fiber).

A beam expansion technique using tapered optical features can be employed to provide an alignment tolerance on the order of 5 μm to 25 μm when coupling the optical fiber 106 with a waveguide within the PIC die 112. While beam expansion can be achieved with lenses, the tapered first or second optical features 102, 108 advantageously provide a substantially more compact way to implement beam expansion. In embodiments, the average diameter of a tapered optical feature is less than 10 μm. In comparison, a lens may have diameter exceeding 100 μm and a volume that may be 100 times greater than that of the tapered optical feature. As noted, this size difference makes fabricating tapered optical features more efficient than printing lenses by over a factor of 100.

In some embodiments, the first optical feature 102 is in a position that is adjacent to the second optical feature 108. When the features are in an adjacent positional relationship, the first optical feature 12 and the second optical feature 108 are operable to couple optical signals between the optical fiber and the PIC die. FIG. 1E illustrates aspects of the positional relationship and optical coupling. FIG. 1E illustrates a cross-sectional view of region 122 optical fiber 106 and PIC die 112 depicted in FIG. 1A, in accordance with some embodiments. For purposes of clarity in the drawings, FIG. 1E illustrates the same view of region 122 depicted in FIG. 1B, but with reference numbers/letters directed to different aspects of the example.

Referring to in FIG. 1E, the first tapered end 130 of first optical feature 102 is adjacent to the second tapered end 134 of the second optical feature 108. In addition, FIG. 1E shows shapes 140a, which symbolically depict the MFD of an optical signal within optical fiber 106 and waveguide 120. FIG. 1E also shows shapes 140b, which symbolically depict the MFD of an optical signal within first optical feature 102 and second optical feature 108. It may be seen that the MFD is expanded (near the respective tapered ends) when propagating in the optical features 102, 108 in comparison to when propagating in the optical fiber 106 and waveguide 120.

Still referring to in FIG. 1E, the second tapered end 134 of the second optical feature 108 may be spaced apart from the first tapered end 130 of the first optical feature 102 by a distance G. First optical feature 102 may have a length L in the x-direction. The length L may be in a range of 50 μm to 500 μm in some embodiments. In embodiments, the average diameter of a tapered optical feature is less than 10 μm. The distance G may be 100 μm to 2000 μm in the x-direction in some embodiments.

As illustrated in FIG. 1E, a longitudinal axis 138 of the first optical feature 102 may be substantially in longitudinal alignment with a longitudinal axis 139 of the second optical feature 108. For example, longitudinal axis 138 may be located at a center of core 124 and extend in the x-direction. A longitudinal axis 139 may be located at a center of end surface 136 of waveguide 120 and extend in the x-direction. Longitudinal axis 138 may be in longitudinal alignment with a longitudinal axis 139 with a tolerance on the order of 5 μm to 25 μm.

FIG. 2 illustrates an isometric view of an optical fiber 206 and a PIC die 212 in which a first optical feature 202 is adjacent to a second optical feature 208, according to some embodiments. FIG. 2 illustrates aspects of the positional relationship between a first optical feature on an optical fiber and a second optical feature on an end surface of a waveguide of a PIC die. In FIG. 2, the first optical feature 202 is on, at, or proximal to an end face 204 of optical fiber 206 and is tapered away from the end face 204. Second optical feature 208 is on, at, or proximal to a surface 210 of PIC die 212 and is tapered away from the surface 210. Second optical feature 208 includes a second base end that is proximal to, at, or on end surface 236 of a waveguide within the PIC die 212. First optical feature 202, end face 204, optical fiber 206, second optical feature 208, surface 210, end surface 236, and PIC die 212 may be the same as or similar to the corresponding parts in FIGS. 1A-1E.

Surface 210 is referred to as “first” surface 210 with respect to FIG. 2. PIC die 212 includes a second surface 250 orthogonal to first surface 210, and a third surface 252 orthogonal to both first surface 250 and second surface 252. In the example presented in FIG. 2, second surface 250 may be a top surface, and third surface 252 may be a left-side surface. FIG. 2 illustrates two planes. A first plane P1 is defined by x and y dimensions. The second (or top) surface 250 may be in the first plane P1. A second plane P2 is defined by z and x dimensions. The third (or side) surface 252 may be in the second plane P2.

As may be seen in FIG. 2, the second base end of optical feature 208 and end surface 236 are a first distance D3 from the first surface 250 and a second distance D4 from the second surface 252. Like the second base end of optical feature 208 and end surface 236, the end face 204 of optical fiber 206 is spaced away from the first plane P1 by the first distance D3 and spaced away from the second plane P2 by the second distance D4. In addition, the end face 204 is facing toward and parallel with the first surface 210. This position and orientation of the first optical feature with respect to the second optical feature makes them operable to couple optical signals between the optical fiber 206 and the PIC die 212 using beam expansion.

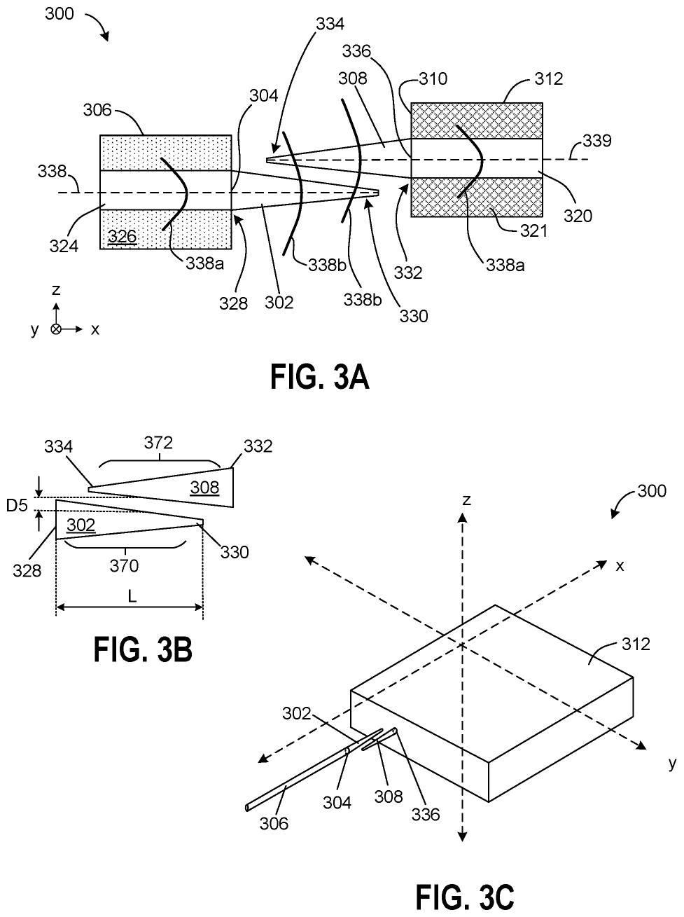

FIG. 3A illustrates a cross-sectional side view of an apparatus 300 that includes an optical fiber 306 and PIC die 312 in which a first optical feature 302 is adjacent and parallel to a second optical feature 308, in accordance with some embodiments. FIG. 3B illustrates a side view first optical feature 302 and second optical feature 308 depicted in FIG. 3A. FIG. 3C illustrates an isometric view of the apparatus 300. First optical feature 302, optical fiber 306, second optical feature 308, and PIC die 312 may be the same as or similar to the corresponding parts described with reference to FIGS. 1A-1E. However, first optical feature 302 and second optical feature 308 are in a parallel positional relationship, whereas the first optical feature 102 and second optical feature 108 are in a longitudinally aligned positional relationship.

The first optical feature 302 may be proximal to, at, or on an end face 304 of core 324 of optical fiber 306. The core 324 may be cylindrical in cross section and surrounded by cladding 326. The first optical feature 302 may taper in a first longitudinal direction from a first base end 328 proximal, at, or on the end face 304 to a first tapered end 330. PIC die 312 includes a surface 310 and a waveguide 320. PIC die 312 includes a surface 310, material 321, and a waveguide 320. The second optical feature 308 is proximal to, at, or on a surface of the PIC die 312, e.g., the surface 310. The second optical feature 308 may taper in a second longitudinal direction from a second base end 332 proximal to, at, or on the surface of PIC die 312 to a second tapered end 334. (The second direction may be opposite the first direction.) In an embodiment, an end surface 336 of waveguide 320, may terminate at surface 310, and the second base end 332 may be proximal to, at, or on end surface 336 of waveguide 320. In addition, the second base end 332 of the second optical feature 308 is at the surface 310 of the PIC die 312. Shapes 338a symbolically depict the MFD of an optical signal within optical fiber 306 and waveguide 320. Shapes 338b symbolically depict the MFD of an optical signal within first optical feature 302 and second optical feature 308.

Optical fiber 306 may be held in positional relationship with PIC die 312 by any suitable device or feature. For example, optical fiber 306 may be held in positional relationship with PIC die 312 with a fiber array unit (FAU), a ferrule, a housing, or by a V-groove in a surface of the PIC die 312 (not shown in FIG. 3A). While a single optical fiber 306 is illustrated, it should be appreciated that multiple optical fibers 306 may be held in positional relationship with PIC die 312 in some embodiments.

The first optical feature 302 is adjacent and parallel to the second optical feature 308. As may be seen in FIG. 3B, first optical feature 302 includes a first section 370 between first base end 328 and first tapered end 330. In addition, second optical feature 308 includes a second section 372 between second base end 332 and second tapered end 334. First section 370 of first optical feature 302 may be adjacent to second section 372 of the second optical feature 308. In some embodiments, the first optical feature 302 is laterally adjacent to the second optical feature 308. In some embodiments, first section 370 of the first optical feature 302 is laterally adjacent to the second section 372 of the second optical feature 308.

The length L of an optical feature 302, 308 may be in a range of 50 μm to 500 μm in some embodiments. In embodiments, the average diameter of a tapered optical feature is less than 10 μm. The first optical feature 302 may be spaced apart from the second optical feature 308 by a distance D5. The distance D5 may be in a range of 0.5 μm to 5 μm in some embodiments. In some embodiments, first optical feature 302 is spaced apart from the second optical feature 308 by a distance that is fifty percent or less of the average diameter of a tapered optical feature 302 or 308.

A longitudinal axis 338 of the first optical feature 302 is parallel to a longitudinal axis 339 of the second optical feature 308. In the example shown in FIGS. 3A and 3B, longitudinal axes 338 and 339 are in the x direction. Longitudinal axes 338, 339 may be in the center of the respective first and second optical features 302, 308. While FIG. 3A shows the first optical feature 302 below (in the z-direction) the second optical feature 308, in some embodiments, the first optical feature 302 may be above second optical feature 308. In addition, the first optical feature 302 may be to a side (in the y-direction) of second optical feature 308 in some embodiments.

The first optical feature 302 and the second optical feature 308 may be operable to evanescently couple optical signals between the optical fiber 306 and the PIC die 312 when portions of the features are laterally adjacent and parallel as described above. For the case of light propagating in the optical fiber 306, the mode confinement factor diminishes as the tapered first optical feature 302 narrows. This leads to an increase in the optical field extending outside first optical feature 302. Energy outside of the optical core is referred to as an evanescent field. If the second optical feature 308 is positioned within the evanescent field of first optical feature 302, the optical mode can transfer evanescently to the second optical feature 308. More generally, if a tapered receiver optical feature is positioned within the evanescent field of a tapered transmitting optical feature, the optical mode can transfer evanescently to the receiving feature without leakage into free space. This phenomenon is known as evanescent coupling.

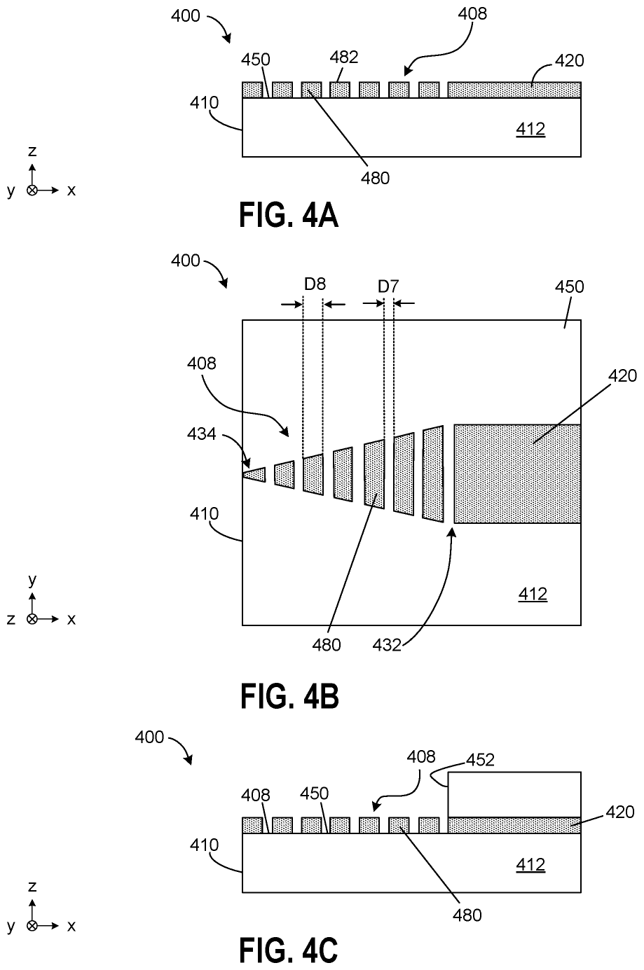

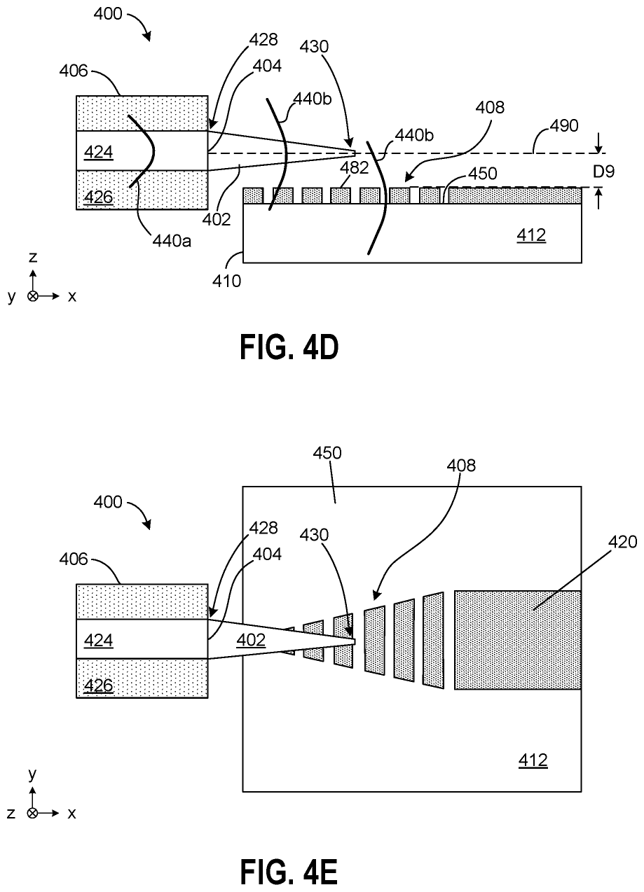

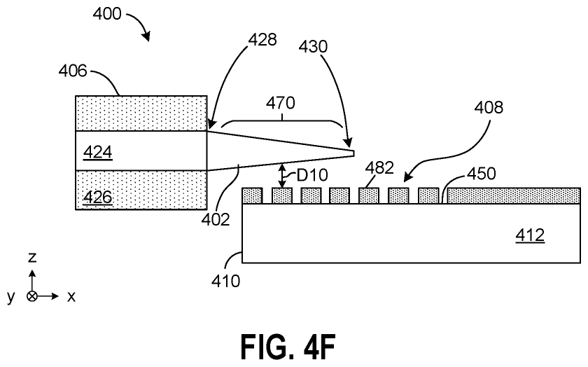

FIGS. 4A-4F illustrate views of an apparatus 400 that includes a first optical feature at, or on, an end face of an optical fiber coupled with a second optical feature on a surface of a PIC die, in accordance with some embodiments. FIG. 4A is a cross-sectional side view of a portion of a PIC die 412. FIG. 4B is a plan view of the portion of the PIC die 412 shown in FIG. 4A. PIC die 412 includes a surface 410, a second optical feature 408 on a surface 450, and a waveguide 420. The surface 410 may be orthogonal to surface 450. FIG. 4C is a cross-sectional side view of a portion of PIC die 412 according to another example. As may be seen in FIG. 4A, waveguide 420 may be on surface 450, or within PIC die 412, e.g., in a layer, as depicted in FIG. 4C. When waveguide 420 is within PIC die 412, it may have an end at a surface 452, which may be orthogonal to the surface 450.

Referring to FIG. 4B, second optical feature 408 may be on surface 450 and taper in a longitudinal direction from a second base end 432 of the feature to a second tapered end 434. The second tapered end 434 may be at or proximal to the first surface 410 of PIC die 412. The second optical feature 408 may include a plurality of spaced apart structures 480 such that the second optical feature 408 functions as metamaterial. A pitch dimension D7 separates the structures 480, which have a length D8. The duty cycle of the periodic structures is distance D8 divided by the sum of distances D7 and D8, i.e., D8/(D7+D8). In this context, a metamaterial comprises multiple structures with periodic features having sub-wavelength sizes. Because the pitch dimension of the periodic structures is smaller than that of the wavelength of propagating light, the individual structures of the metamaterial are not resolvable to the incident light. In various embodiments, all of the sub-wavelength sized structures 480 collectively act as a metamaterial and are not resolvable to the incident light.

Structures 480 of second optical feature 408 may comprise silicon, semiconductor materials, or dielectric materials and be fabricated using conventional lithography. The spacing and duty cycle of the periodic structures may be adjusted so that the effective refractive index of the entire second optical feature 408 is modulated to closely approach that of the cladding material of the optical fiber. By adjusting the spacing and duty cycle, the beam size of propagating light may be expanded (or contracted, depending on direction of travel) to a size in a range of 10 μm to 100 μm. This beam expansion property enables the second optical feature 408 to be evanescently coupled with a first optical feature 402 when the optical features 402, 408 are adjacent, and the first optical feature 402 is parallel to the second surface 450 (or parallel to a surface 482 of optical features 408, which is opposite second surface 450).

Referring to FIG. 4B, in some embodiments, the optical wavelength used with apparatus 400 may be 1.31 μm and a pitch dimension D7 between the structures 480 may be in a range of 0.1 μm to 1.0 μm. In some embodiments, a length D8 of a structure 480 in a longitudinal direction (in the x-direction) may be in a range of 0.1 μm to 1.0 μm.

One advantage of second optical feature 408 is that it is not necessary to employ a 2PP polymerization printing process to fabricate structures 480, however, this is not essential. In some embodiments, structures 480 be may be printed using a 2PP polymerization process. Nor is it critical that structures 480 be fabricated with lithography, any suitable technique may be used. A further advantage is that system complexity is reduced when the second optical feature 408 is formed on surface 450. As 2PP printing of an optical feature is only required on the optical fiber, the optical feature on the fiber can be pre-printed prior to assembly of the fiber with the PIC die. This can enhance the efficiency of the assembly workflow for mass production.

FIG. 4D illustrates a side view of apparatus 400 in which a first optical feature 402 is at, or on, an end face of an optical fiber adjacent to and parallel with second optical feature 408 on a surface of a PIC die, in accordance with some embodiments. FIG. 4E is a plan view of the portion of the PIC die 412 shown in FIG. 4D. The first optical feature 402 is proximal to an end face 404 of optical fiber 406 and tapered in a direction away from end face 404. The core 424 may be cylindrical in cross section and surrounded by cladding 426. A longitudinal axis 490 of the first optical feature 402 may be substantially parallel to the second surface 450 and offset in a lateral direction (in the z direction in FIG. 4D) from a surface 482 of the second optical feature 408 by a distance D9. The first optical feature 402 is adjacent to the second optical feature 408 in a spatial relationship that, along with the respective tapered attributes, make the first and second optical features 402, 408 operable to evanescently couple optical signals between the optical fiber 406 and the PIC die 412. Shape 440a symbolically depicts the MFD of an optical signal within optical fiber 406. Shapes 440b symbolically depict the MFD of an optical signal within first optical feature 402 and second optical feature 408.

FIG. 4F illustrates a side view of first optical feature 402 at, or on, an end face of an optical fiber adjacent to and coupled with second optical feature 408 on a surface of a PIC die, in accordance with some embodiments. For purposes of clarity in the drawings, FIG. 4F illustrates the same view of depicted in FIG. 4D, but with reference numbers/letters directed to different aspects of the example. As may be seen in FIG. 4F, the first optical feature 402 comprises a section 470 between the first tapered end 430 and the first base end 428. In embodiments, the average diameter of optical feature 402 is less than 10 μm. A distance D10 may be between first optical feature 402 and second optical feature 408. Alternatively, distance D10 may be between first optical feature 402 and surface 450. The distance D10 may be in a range of 0.5 μm to 5 μm. In various embodiments, section 470 is spaced apart in a lateral direction (z-direction) from the surface 482 of the second optical feature 408, or from surface 450 by a distance D10 that is less than fifty percent of the average diameter of optical feature 402.

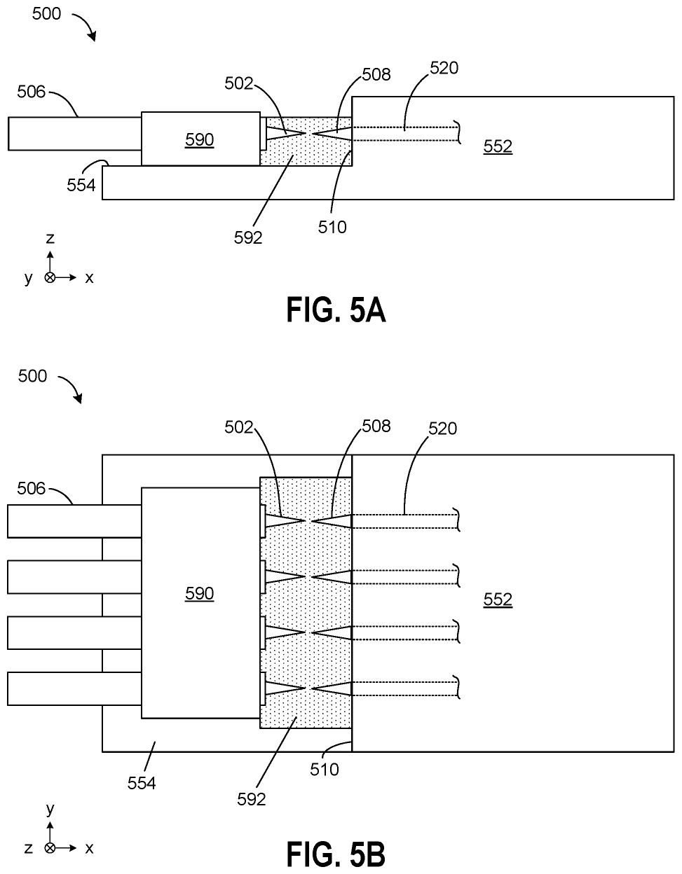

FIG. 5A illustrates a cross-sectional side view of an apparatus comprising a plurality of first optical features, each at an end face of an optical fiber, a plurality of second optical features on a surface of a PIC die, and a fiber holding feature, in accordance with some embodiments. FIG. 5B illustrates a plan side view of the apparatus depicted in FIG. 5A.

The apparatus 500 includes a plurality of first optical features 502, each at an end face of an optical fiber 506. First optical features 502 and optical fibers 506 may be the same as, or similar to, first optical features 102 and optical fibers 106. Apparatus 500 also includes a PIC die 552. The PIC die 552 includes a surface 510 and a plurality of waveguides 520 within the PIC die 552. Each waveguide 520 may have an end surface at surface 510. A plurality of second optical features 508 are on the surface 510 of PIC die 552. Second optical features 508 may be the same as, or similar to, second optical features 108. When the first and second optical features 502, 508 are in an adjacent positional relationship, the first optical features are operable to couple optical signals between the optical fiber 506 and the PIC die 552.

The apparatus 500 includes a component 590 attached to surface 554 of PIC die 552. FIG. 5A shows one illustrative example of how component 590 may be attached to PIC die 552. Apparatus 500 is not limited to this example. Component 590 may be attached to PIC die 552 in any suitable manner known in the art. Component 590 comprises a fiber holding feature to retain the optical fibers 506. In one example, optical fibers 506 may be retained within through holes in component 590. Again, apparatus 500 is not limited to this example. Optical fibers 506 may be retained by apparatus 500 in in any suitable manner known in the art. In some embodiments, optical fibers 506 may be retained by V-shaped grooves on surface 554.

The apparatus 500 may include a material 592 that encapsulates the first and second optical features 502, 508. The material 592 may serve to protect the optical features from the environment. The material 592 may be an epoxy, a polymer, an oil, or other material have a suitable refractive index. As described above, the first optical feature may comprise a polymer material and the second optical feature may comprise a polymer. The first optical feature 502, second optical feature 508, and the encapsulating material 592 may each have a different material composition, in various embodiments.

The PIC die 552 comprises a plurality of waveguides 520. In some embodiments, the waveguides 520 may comprise silicon, and the second optical features 508 may comprise a polymer.

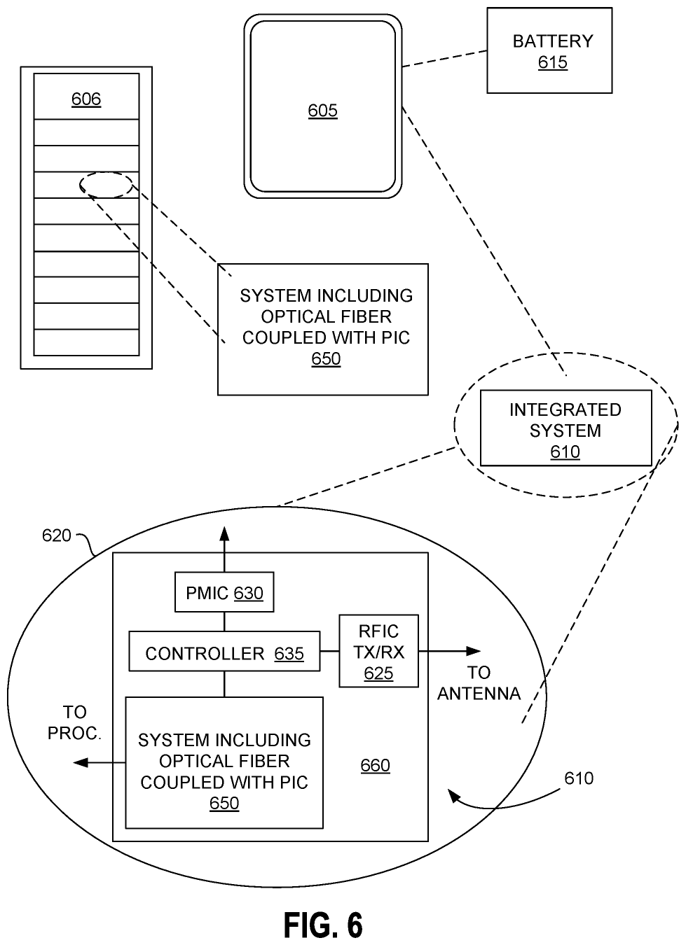

FIG. 6 illustrates a mobile computing platform and a data server machine employing one or more apparatus comprising an optical feature at an end face of an optical fiber coupled with an optical feature on a surface of a PIC die, for example as described elsewhere herein. For example, mobile computing platform 605 or server machine 606 may include an optical fiber coupled with a PIC die as described elsewhere herein. Server machine 606 may be any commercial server, for example including any number of high-performance computing platforms disposed within a rack and networked together for electronic data processing. The mobile computing platform 605 may be any portable device configured for each of electronic data display, electronic data processing, wireless electronic data transmission, or the like. For example, the mobile computing platform 605 may be any of a tablet, a smart phone, laptop computer, etc., and may include a display screen (e.g., a capacitive, inductive, resistive, or optical touchscreen), a chip-level or package-level integrated system 610, and a battery 615.

Whether disposed within the integrated system 610 illustrated in the expanded view 620, or as a stand-alone package within the server machine 606, the integrated system or server machine includes an apparatus comprising an optical feature at an end face of an optical fiber coupled with an optical feature on a surface of a PIC die, as described elsewhere herein. System 650 may be further coupled to a host substrate 660, along with, one or more of a power management integrated circuit (PMIC) 630, RF (wireless) integrated circuit (RFIC) 625 including a wideband RF (wireless) transmitter and/or receiver (TX/RX) (e.g., including a digital baseband and an analog front-end module further comprises a power amplifier on a transmit path and a low noise amplifier on a receive path), and a controller 635. PMIC 630 may perform battery power regulation, DC-to-DC conversion, etc., and so has an input coupled to battery 615 and with an output providing a current supply to other functional modules. As further illustrated, in the exemplary embodiment, RFIC 625 has an output coupled to an antenna (not shown) to implement any of a number of wireless standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, derivatives thereof, as well as any other wireless protocols that are designated as 3G, 4G, 4G, and beyond.

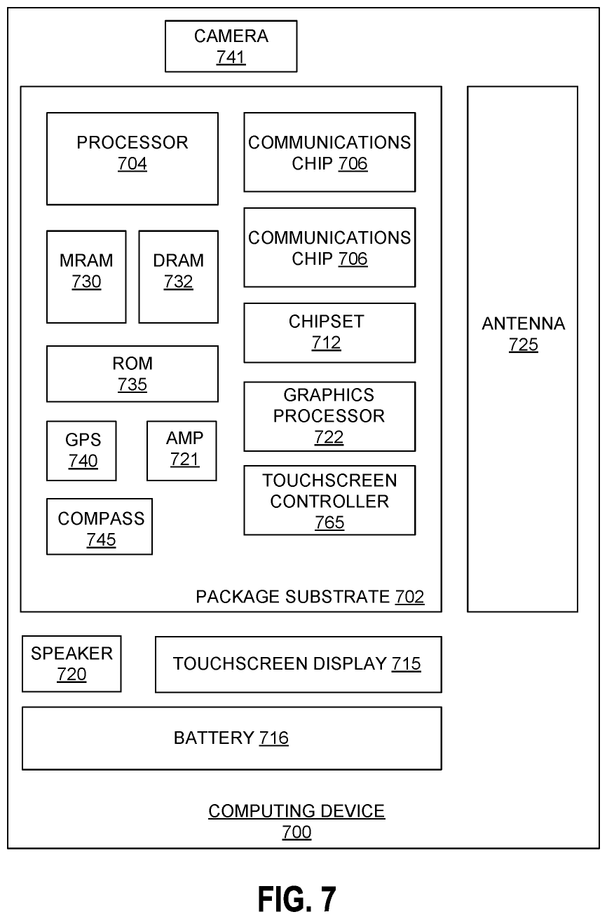

FIG. 7 is a functional block diagram of an electronic computing device 700, in accordance with an embodiment of the present invention. The computing device may be found inside mobile computing platform 605 or server machine 606, as described elsewhere herein. Device 700 further includes a package substrate 702 hosting a number of components, such as, but not limited to, a processor 704 (e.g., an applications processor). Processor 704 may be physically and/or electrically coupled to package substrate 702. In general, the term “processor” or “microprocessor” may refer to any device or portion of a device that processes electronic data from registers and/or memory to transform that electronic data into other electronic data that may be further stored in registers and/or memory. In some examples, one or more of the components of computing device 700 includes an apparatus comprising an optical feature at an end face of an optical fiber coupled with an optical feature on a surface of a PIC die, as described elsewhere herein.

In various examples, one or more communication chips 706 may also be physically and/or electrically coupled to the package substrate 702. In further implementations, communication chips 706 may be part of processor 704. Depending on its applications, computing device 700 may include other components that may or may not be physically and electrically coupled to package substrate 702. These other components include, but are not limited to, volatile memory (e.g., DRAM 732), non-volatile memory (e.g., ROM 735), flash memory (e.g., NAND or NOR), magnetic memory (MRAM 730), a graphics processor 722, a digital signal processor, a crypto processor, a chipset 712, an antenna 725, touchscreen display 715, touchscreen controller 765, battery 716, audio codec, video codec, power amplifier 721, global positioning system (GPS) device 740, compass 745, accelerometer, gyroscope, speaker 720, camera 741, and mass storage device (such as hard disk drive, solid-state drive (SSD), compact disk (CD), digital versatile disk (DVD), and so forth), or the like . . .

Communication chips 706 may enable wireless communications for the transfer of data to and from the computing device 700. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. Communication chip 706 may implement any of a number of wireless standards or protocols. As discussed, computing device 700 may include a plurality of communication chips 706. For example, a first communication chip may be dedicated to shorter-range wireless communications, such as Wi-Fi and Bluetooth, and a second communication chip may be dedicated to longer-range wireless communications such as GPS, EDGE, GPRS, CDMA, WiMAX, LTE, Ev-DO, and others.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

It will be recognized that the invention is not limited to the embodiments so described, but can be practiced with modification and alteration without departing from the scope of the appended claims. For example, the above embodiments may include specific combinations of features as further provided below.

Example 1: An apparatus comprising: an optical fiber comprising a first feature at an end face of the optical fiber, the first feature tapering in a first longitudinal direction from a first base end proximal to the end face to a first tapered end; a photonic integrated circuit (PIC) die comprising a second feature at a surface of the PIC die, the second feature tapering in a second longitudinal direction from a second base end to a second tapered end; and wherein the first feature is adjacent to the second feature.

Example 2: The apparatus of example 1, wherein the surface is a first surface, and: the PIC die comprises a second surface orthogonal to the first surface, and a third surface orthogonal to both the first surface and the second surface, wherein the second surface is in a first plane, and the third surface is in a second plane; the second base end is proximal to the first surface, spaced away from the second surface by a first distance, and spaced away from the third surface by a second distance; the first base end is spaced away from the first plane by the first distance and spaced away from the second plane by the second distance; and wherein the first feature and the second feature are operable to couple optical signals between the optical fiber and the PIC die.

Example 3: The apparatus of example 2, wherein the first tapered end is spaced apart from the second tapered end by a distance in the first longitudinal direction.

Example 4: The apparatus of example 1, wherein: the first feature comprises a first section between the first tapered end and the first base end; the second feature comprises a second section between the second tapered end and the second base end; the second base end is proximal to the surface, and the first section is laterally adjacent to the second section; and wherein the first feature and the second feature are operable to evanescently couple optical signals between the optical fiber and the PIC die.

Example 5: The apparatus of example 4, wherein the section is spaced apart from the second tapered end by a distance that is fifty percent or less of an average diameter of the first or second feature.

Example 6: The apparatus of example 1, wherein: the surface of the PIC die is a first surface and the PIC die comprises a second surface orthogonal to the first surface; the second feature is on the second surface and the second tapered end is proximal to the first surface; and the first feature is parallel to and laterally offset from the second surface, wherein the first feature and the second feature are operable to evanescently couple optical signals between the optical fiber and the PIC die.

Example 7: The apparatus of example 6, wherein: the first feature comprises a section between the first tapered end and the first base end; and the section is laterally offset from the second surface by a distance that is fifty percent or less of an average diameter of the first feature.

Example 8: The apparatus of example 6, wherein the second feature comprises a plurality of spaced apart structures, wherein a pitch distance between structures is in a range of 0.1 μm to 1.0 μm.

Example 9: The apparatus of example 1, wherein the first feature comprises a first polymer material, the second feature comprises a second polymer material, and the first feature and the second feature are encapsulated in a third polymer material different from the first and second polymer materials.

Example 10: The apparatus of example 1, wherein the PIC die comprises a waveguide and a waveguide end, wherein the second base end is proximal to the waveguide end.

Example 11: The apparatus of example 1, wherein the optical fiber comprises a glass core surrounded by a cladding and the first feature comprises a polymer.

Example 12: The apparatus of example 1, further comprising a component comprising a fiber holding feature to retain the optical fiber and an attachment feature to hold the component in a fixed relation with the PIC die.

Example 13: An apparatus comprising: a first optical waveguide comprising a first tapered section, wherein the first tapered section has a lateral dimension that diminishes in a first direction along a length of the first tapered section; a second optical waveguide comprising a second tapered section, wherein the second tapered section has a lateral dimension that increases in the first direction along a length of the second tapered section; and wherein the first and second tapered sections are adjacent and spaced apart by a distance.

Example 14: The apparatus of example 13, further comprising an optical fiber and a photonic integrated circuit (PIC) die, wherein: the first tapered section is at an end face of the optical fiber; the second tapered section is at a surface of the PIC die; and the first and second tapered sections are adjacent to one another in the first direction, wherein the first and second tapered sections are operable to couple optical signals between the optical fiber and the PIC die.

Example 15: The apparatus of example 13, further comprising an optical fiber and a PIC die, wherein: the first tapered section comprises an optical fiber; and the second tapered section is at a surface of the PIC die; and the first and second tapered sections are laterally adjacent and parallel, wherein the first and second tapered sections are operable to couple optical signals between the optical fiber and the PIC die.

Example 16: The apparatus of example 15, wherein the second tapered section extends away from the surface.

Example 17: The apparatus of example 15, wherein the second tapered section extends along the surface.

Example 18: An assembly comprising: an optical fiber comprising a first optical feature tapering in a first longitudinal direction from a first base end at an end face of the optical fiber to a first tapered end; a photonic integrated circuit (PIC) die comprising:
a second optical feature tapering in a second longitudinal direction from a second base end to a second tapered end, wherein the second optical feature is at a surface of the PIC die, and a waveguide adjacent to the second base end; and a housing to retain the optical fiber in a position in which the first optical feature is adjacent to the second optical feature.

Example 19: The assembly of example 18, wherein: the first base end faces the surface; and a longitudinal axis of the first optical feature is longitudinally aligned with a longitudinal axis of the second optical feature, wherein the first optical feature and the second optical feature are operable to couple an optical signal between the optical fiber and the waveguide.

Example 20: The assembly of example 18, wherein: the first optical feature is parallel to the second optical feature, and the first optical feature and the second optical feature are operable to evanescently couple an optical signal between the optical fiber and the waveguide.

What is claimed is:

1. An apparatus comprising:
an optical fiber comprising a first feature at an end face of the optical fiber, the first feature tapering in a first longitudinal direction from a first base end proximal to the end face to a first tapered end;
a photonic integrated circuit (PIC) die comprising a second feature at a surface of the PIC die,
the second feature tapering in a second longitudinal direction from a second base end to a second tapered end; and
wherein the first feature is adjacent to the second feature.

2. The apparatus of claim 1, wherein the surface is a first surface, and:
the PIC die comprises a second surface orthogonal to the first surface, and a third surface orthogonal to both the first surface and the second surface, wherein the second surface is in a first plane, and the third surface is in a second plane;
the second base end is proximal to the first surface, spaced away from the second surface by a first distance, and spaced away from the third surface by a second distance;
the first base end is spaced away from the first plane by the first distance and spaced away from the second plane by the second distance; and
wherein the first feature and the second feature are operable to couple optical signals between the optical fiber and the PIC die.

3. The apparatus of claim 2, wherein the first tapered end is spaced apart from the second tapered end by a distance in the first longitudinal direction.

4. The apparatus of claim 1, wherein:
the first feature comprises a first section between the first tapered end and the first base end;
the second feature comprises a second section between the second tapered end and the second base end;
the second base end is proximal to the surface, and the first section is laterally adjacent to the second section; and
wherein the first feature and the second feature are operable to evanescently couple optical signals between the optical fiber and the PIC die.

5. The apparatus of claim 4, wherein the first section is spaced apart from the second section by a distance that is fifty percent or less of an average diameter of the first or second feature.

6. The apparatus of claim 1, wherein:
the surface of the PIC die is a first surface and the PIC die comprises a second surface orthogonal to the first surface;
the second feature is on the second surface and the second tapered end is proximal to the first surface; and
the first feature is parallel to and laterally offset from the second surface, wherein the first feature and the second feature are operable to evanescently couple optical signals between the optical fiber and the PIC die.

7. The apparatus of claim 6, wherein:
the first feature comprises a section between the first tapered end and the first base end; and
the section is laterally offset from the second surface by a distance that is fifty percent or less of an average diameter of the first feature.

8. The apparatus of claim 6, wherein the second feature comprises a plurality of spaced apart structures, wherein a pitch distance between structures is in a range of 0.1 μm to 1.0 μm.

9. The apparatus of claim 1, wherein the first feature comprises a first polymer material, the second feature comprises a second polymer material, and the first feature and the second feature are encapsulated in a third polymer material different from the first and second polymer materials.

10. The apparatus of claim 1, wherein the PIC die comprises a waveguide and a waveguide end, wherein the second base end is proximal to the waveguide end.

11. The apparatus of claim 1, wherein the optical fiber comprises a glass core surrounded by a cladding and the first feature comprises a polymer.

12. The apparatus of claim 1, further comprising a component comprising a fiber holding feature to retain the optical fiber and an attachment feature to hold the component in a fixed relation with the PIC die.

13. An apparatus comprising:
a first optical waveguide comprising a first tapered section, wherein the first tapered section has a lateral dimension that diminishes in a first direction along a length of the first tapered section;
a second optical waveguide comprising a second tapered section, wherein the second tapered section has a lateral dimension that increases in the first direction along a length of the second tapered section; and
wherein the first and second tapered sections are adjacent and spaced apart by a distance.

14. The apparatus of claim 13, further comprising an optical fiber and a photonic integrated circuit (PIC) die, wherein:
the first tapered section is at an end face of the optical fiber;
the second tapered section is at a surface of the PIC die; and
the first and second tapered sections are adjacent to one another in the first direction, wherein
the first and second tapered sections are operable to couple optical signals between the optical fiber and the PIC die.

15. The apparatus of claim 13, further comprising an optical fiber and a PIC die, wherein:
the first tapered section comprises the optical fiber; and
the second tapered section is at a surface of the PIC die; and
the first and second tapered sections are laterally adjacent and parallel, wherein the first and second tapered sections are operable to couple optical signals between the optical fiber and the PIC die.

16. The apparatus of claim 15, wherein the second tapered section extends away from the surface.

17. The apparatus of claim 15, wherein the second tapered section extends along the surface.

18. An assembly comprising:
an optical fiber comprising a first optical feature tapering in a first longitudinal direction from a first base end at an end face of the optical fiber to a first tapered end;
a photonic integrated circuit (PIC) die comprising:
a second optical feature tapering in a second longitudinal direction from a second base end to a second tapered end, wherein the second optical feature is at a surface of the PIC die, and
a waveguide adjacent to the second base end; and
a housing to retain the optical fiber in a position in which the first optical feature is adjacent to the second optical feature.

19. The assembly of claim 18, wherein:
the first base end faces the surface; and
a longitudinal axis of the first optical feature is longitudinally aligned with a longitudinal axis of the second optical feature, wherein the first optical feature and the second optical feature are operable to couple an optical signal between the optical fiber and the waveguide.

20. The assembly of claim 18, wherein:
the first optical feature is parallel to the second optical feature, and the first optical feature and the second optical feature are operable to evanescently couple an optical signal between the optical fiber and the waveguide.
